(19) United States
(12) Patent Application Publication
(10) Pub. No.: US 2025/0388413 A1
(43) Pub. Date: Dec. 25, 2025

(54) COAL BLENDING AND BURNING SYSTEM BASED ON BELT CONVEYORS WITH VERTICAL PROCESS MODULES

(71) Applicant: HUANENG POWER INTERNATIONAL, INC. SHANGHAI SHIDONGKOU FIRST POWER PLANT, Shanghai (CN)

(72) Inventors: Jiawei Wu, Shanghai (CN); Yijie Zhang, Shanghai (CN); Yongyan Chen, Shanghai (CN); Haifeng Guan, Shanghai (CN); Siwen Li, Shanghai (CN); Jiyuan Liu, Shanghai (CN); Shaonan Chen, Shanghai (CN); Kun Zhou, Shanghai (CN); Junjie Di, Shanghai (CN); Baozhong Tian, Shanghai (CN)

(73) Assignee: HUANENG POWER INTERNATIONAL, INC. SHANGHAI SHIDONGKOU FIRST POWER PLANT, Shanghai (CN)

(21) Appl. No.: 19/251,835

(22) Filed: Jun. 27, 2025

Related U.S. Application Data
(63) Continuation of application No. PCT/CN2025/098564, filed on May 30, 2025.

(30) Foreign Application Priority Data
Jun. 21, 2024 (CN) 202410806685.2

(51) Int. Cl. B65G 47/46; B65G 47/44; F23K 1/00; F23K 3/00

(52) U.S. Cl. CPC B65G 47/46; B65G 47/44; F23K 1/00; F23K 3/00; B65G 2201/042; B65G 2203/0258; B65G 2203/0283

(57) ABSTRACT

A coal blending and burning system based on a belt conveyor with a vertical process module includes a coal feeding system No. 1 provided with discharge ports 1A and 1B for outputting a coal type A; a coal feeding system No. 2 provided with discharge ports 2A and 2B for outputting a coal type B; a first belt conveyor A provided with electronic scales 1A and 2A, respectively; a first belt conveyor B provided with electronic scales 1B and 2B, respectively; a vertical drop tube; a second belt conveyor for transporting coal materials output from the vertical drop tube; a third belt conveyor for transporting coal materials output from the second belt conveyor to a coal supply end; and a controller for controlling coal blending on the first belt conveyor A, the first belt conveyor B, or the second belt conveyor.

### CROSS-REFERENCE TO RELATED APPLICATION

This application is a continuation of International Application of PCT application serial no. PCT/CN2025/098564 filed on May 30, 2025, which claims the priority benefit of China application serial no. 202410806685.2 filed on Jun. 21, 2024. The entirety of each of the above-mentioned patent applications is hereby incorporated by reference herein and made a part of this specification.

### BACKGROUND

### Technical Field

The present invention relates to the field, and in particular to a coal blending and burning system based on a belt conveyor with a vertical process module.

### Description of Related Art

In coal transportation systems, coal blending and burning are often required to achieve the purposes such as optimization of coal type characteristics, enhancement of combustion efficiency, reduction of pollutant emissions, improvement of resource utilization, and meeting boiler design requirements.

Existing coal blending methods include a grab bucket method and a coal stacking blending method. The working principle of the grab bucket method is as follows: the grab bucket coefficients for various types of coals are determined according to preset coal blending ratios. Then, a grab bucket machine is used to grab and mix the corresponding quantity of coal, and finally, the blended coal piles are moved to a standby position.

The working principle of the coal stacking blending method is as follows: raw coals of different qualities are stacked together according to a preset ratio and method, and then blended.

However, due to equipment incompatibility, disallowed site conditions, and other all types of circumstances, the coal feeding system may not be suitable for the grab bucket method or the coal stacking blending method, or other coal blending ways.

### SUMMARY

The objective of the present invention is to overcome the defect existing in the aforesaid prior art, i.e., the coal feeding system is not suitable for the grab bucket method or the coal stacking blending method caused by equipment incompatibility, disallowed site conditions, and other all types of circumstances, making it impossible to achieve coal blending. To address this issue, the present invention provides a coal blending and burning system based on a belt conveyor with a vertical process module.

The objective of the present invention can be achieved by the following technical solutions:
a coal blending and burning system based on a belt conveyor with a vertical process module, including
a coal feeding system No. 1, provided with discharge ports 1A and 1B, for outputting a coal type A;
a coal feeding system No. 2, provided with discharge ports 2A and 2B, for outputting a coal type B;
a first belt conveyor A, positioned directly facing the discharge ports 2A and 1A in sequence, and provided with an electronic scale 1A located at a rear side of the discharge port 1A and an electronic scale 2A located at a rear side of the discharge port 2A, respectively;
a first belt conveyor B, positioned directly facing the discharge ports 2B and 1B in sequence, and provided with an electronic scale 1B located at a rear side of the discharge port 1B and an electronic scale 2B located at a rear side of the discharge port 2B, respectively;
a vertical drop tube, provided with an input port located at a top portion and an output port located at a bottom portion; the input port is connected to the first belt conveyors A and B, and the output port is connected to the second belt conveyor;
a second belt conveyor, configured to transport a coal material discharged from the vertical drop tube;
a third belt conveyor, configured to transport a coal material discharged from the second belt conveyor to a coal supply end; and a controller, connected to the coal feeding system No. 1, the coal feeding system No.
the electronic scales 1A, 2A, 1B, and 2B, respectively, for controlling coal blending of the coal 2, types A and B on the first belt conveyor A, the first belt conveyor B, or the second belt conveyor.

Further, a process for controlling coal blending of the coal types A and B on the first belt conveyor A via the controller includes the following steps:
S101: starting a conveyor of the first belt conveyor A; configuring a coal-blending flow rate of the coal type A and a coal-blending flow rate of the coal type B;
S102: starting the coal feeding systems No. 1 and No. 2, opening the discharge ports 1A and 2A, and releasing a coal material onto the first belt conveyor A simultaneously;
S103: determining whether a flow rate detected by the electronic scale 2A matches the coal-blending flow rate of the coal type B; if not, adjusting a discharge amount at the discharge port 2A and repeating step S103; otherwise, executing step S104;
S104: determining whether a difference between a flow rate detected by the electronic scale 1A and the flow rate detected by the electronic scale 2A matches the coal-blending flow rate of the coal type A; if not, adjusting a discharge amount at the discharge port 1A and repeating step S104; otherwise, executing step S105; and
S105: repeating steps S103-S104 until a coal-blending stop command is received.

Further, the process for controlling coal blending of the coal types A and B on the first belt conveyor A via the controller includes the following steps:
S111: starting a conveyor of the first belt conveyor A; configuring a coal-blending flow rate of the coal type A and a coal-blending flow rate of the coal type B;
S112: starting the coal feeding systems No. 1 and No. 2, opening the discharge ports 1B and 2B, and releasing a coal material onto the first belt conveyor B simultaneously;
S113: determining whether a flow rate detected by the electronic scale 2B matches the coal-blending flow rate of the coal type B; if not, adjusting a discharge amount at the discharge port 2B and repeating step S103; otherwise, executing step S104;
S114: determining whether a difference between a flow rate detected by the electronic scale 1B and the flow rate detected by the electronic scale 2B matches the coal-blending flow rate of the coal type A; if not, adjusting a discharge amount at the discharge port 1B and repeating step
S114; otherwise, executing step S115; and
S115: repeating steps S113-S114 until a coal-blending stop command is received.

Further, the process for controlling coal blending of the coal types A and B on the second belt conveyor via the controller includes the following steps:
S201: starting conveyors of the first belt conveyors A and B, respectively; configuring a coal-blending flow rate of the coal type A and a coal-blending flow rate of the coal type B;
S202: starting the coal feeding systems No. 1 and No. 2, opening the discharge ports 1A and 2B, and releasing a coal material onto the first belt conveyors A and B, respectively;
S203: coal materials on the first belt conveyors A and B all dropping onto the second belt conveyor via the vertical drop tube for coal blending;
S204: determining whether a flow rate detected by the electronic scale 1A matches the coal-blending flow rate of the coal type A; if not, adjusting a discharge amount at the discharge port 1A and repeating step S204; determining whether a flow rate detected by the electronic scale 2B matches the coal-blending flow rate of the coal type B; if not, adjusting a discharge amount at the discharge port 2B and repeating step S204; and
S205: repeating step S204 until a coal-blending stop command is received.

Further, the second belt conveyor includes second belt conveyors A and B that are connected in parallel to an output port of the vertical drop tube; the third belt conveyor includes third belt conveyors A and B; the third belt conveyor A is connected to the second belt conveyor A, and the third belt conveyor B is connected to the second belt conveyor B; the third belt conveyor A is provided with a third belt conveyor A electronic scale, and the third belt conveyor B is provided with a third belt conveyor B electronic scale; the vertical drop tube is internally provided with a baffle and a driver for driving the baffle to rotate, for distributing a coal material flowing from the input port of the vertical drop tube onto the second belt conveyors A and B.

Further, the process for controlling coal blending of the coal types A and B on the second belt conveyor via the controller includes the following steps:
S301: starting conveyors of the first belt conveyors A and B, respectively; configuring a coal-blending flow rate of the coal type A and a coal-blending flow rate of the coal type B;
S302: starting the coal feeding systems No. 1 and No. 2, opening the discharge ports 1A and 2B, and releasing a coal material onto the first belt conveyors A and B, respectively;
S303: determining whether a flow rate detected by the electronic scale 1A matches the coal-blending flow rate of the coal type A; if not, adjusting a discharge amount at the discharge port 1A and repeating step S303; determining whether a flow rate detected by the electronic scale 2B matches the coal-blending flow rate of the coal type B; if not, adjusting a discharge amount at the discharge port 2B, and repeating step S303; and
S304: driving the baffle inside the vertical drop tube to rotate via the driver onto a middle position for distributing coal to the second belt conveyors A and B;
S305: determining whether a flow rate detected by the third belt conveyor A electronic scale matches an average value of a sum of the coal-blending flow rates of the coal types A and B; if not, adjusting an angle of the baffle inside the vertical drop tube; determining whether a flow rate detected by the third belt conveyor B electronic scale matches an average value of a sum of the coal-blending flow rates of the coal types A and B; if not, adjusting the angle of the baffle inside the vertical drop tube; and
S306: repeating steps S303-S305 until a coal-blending stop command is received.

Further, the process for controlling coal blending of the coal types A and B on the second belt conveyor via the controller includes the following steps:
S401: starting conveyors of the first belt conveyors A and B, respectively;
S402: starting the coal feeding systems No. 1 and No. 2, opening the discharge ports 1A and 2B, and releasing a coal material onto the first belt conveyors A and B, respectively; and
S403: driving the baffle inside the vertical drop tube to rotate via the driver such that the coal type B drops onto the second belt conveyor A completely, the coal type A is partially mixed with the coal type B via the baffle according to actual coal blending requirements and drops onto the second belt conveyor A, and a remainder drops onto the second belt conveyor B.

Further, the vertical drop tube is further provided with a tilt sensor for measuring a rotation angle of the baffle.

Further, belt conveyors A and B are further disposed at a bottom portion of the vertical drop tube, and configured to transport a coal material to the second belt conveyors A and B, respectively.

Further, the controller further continuously executes an anti-coal-interruption interlocking protection step during the control process of coal blending: after detecting discharge from the coal feeding system 2, the coal feeding system 1 discharges; when coal interruption is detected in either the coal feeding system 1 or the coal feeding system 2, the other coal feeding system stops discharging; and
whether the coal feeding system No. 1 or No. 2 discharges is determined by determining

a flow rate output by the electronic scale disposed at the discharge port of the coal feeding system No. 1 or No. 2.

Compared with the prior art, the present invention has the following advantages:
(1) The present invention innovatively puts forward a coal blending solution on a conveyor of a belt conveyor, and provides a solution for cases where coal feeding systems lack coal blending conditions, which can achieve advantages of high flexibility in switching between single coal type and blended coal, more accurate coal blending ratios, and more thorough mixing between different coal types.
(2) The present invention proposes enabling simultaneous opening of the discharge ports of two different coal feeding systems on the same belt conveyor, and controlling the flow rate of each discharge port to achieve coal blending in proportion. Coal can entirely drop onto a No. 11 belt conveyor through a vertical drop tube for blending, allowing the real-time control of the flow rate on a No. 10 belt conveyor, with the most precise control of proportions. By using baffles, the two coal flows can be evenly distributed onto a No. 11 belt conveyor A/B, ensuring that the No. 11 belt conveyor A/B carries blended coal with the same coal type proportions. This solution guarantees dual-route coal feeding with relatively precise initial proportion control. One coal type can entirely drop onto a single belt; and the other coal type can be adjusted via baffles according to actual coal blending requirements to separate the required flow rate for blending with the previous coal type; the excess flow of the coal type is directed to another belt route. Moreover, proportions can be regulated at two levels using the electronic scale on the No. 12 belt conveyor.
(3) The configuration of the vertical drop tube of the present invention facilitates the diversion of coal types after flowing through baffles after falling, and during the vertical falling, the mixing between different coal types becomes more thorough, thus making the subsequent coal blending and burning effect more effects more stable.

### BRIEF DESCRIPTION OF THE DRAWINGS

FIG. 1 is a schematic diagram showing an overall structure of a coal blending and burning system based on a belt conveyor with a vertical process module provided in an embodiment of the present invention;

FIG. 2 is a process diagram showing direct coal blending on an outlet belt of a coal feeding system provided in an embodiment of the present invention;

FIG. 3 is a process diagram showing direct single-route coal blending on a No. 11 belt conveyor provided in an embodiment of the present invention;

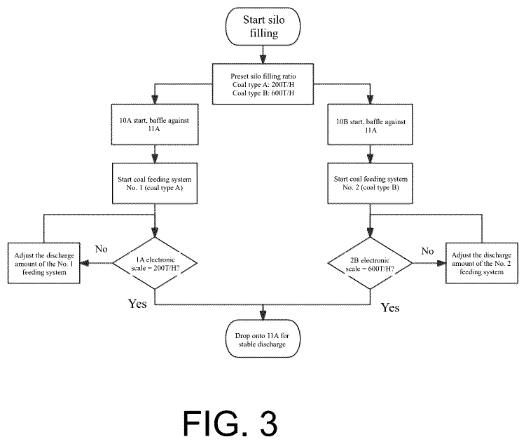

FIG. 4 is a process diagram showing dual-route equal division coal blending (including a protection strategy) on a No. 11 belt conveyor provided in an embodiment of the present invention; and

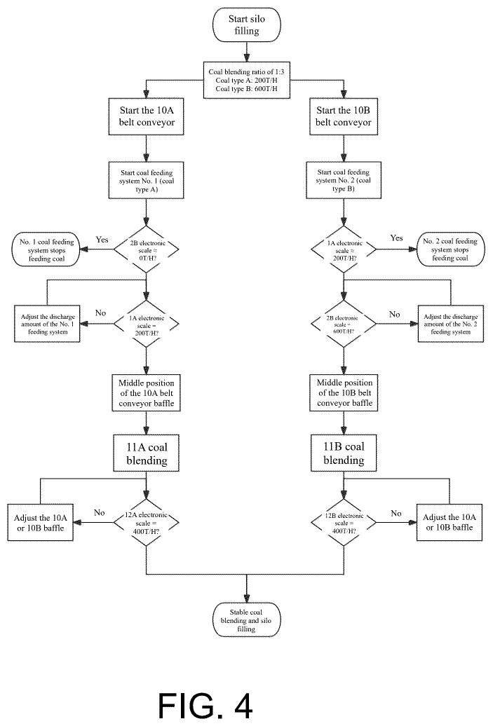

FIG. 5 is a schematic diagram showing a position of a tilt sensor provided in an embodiment of the present invention.

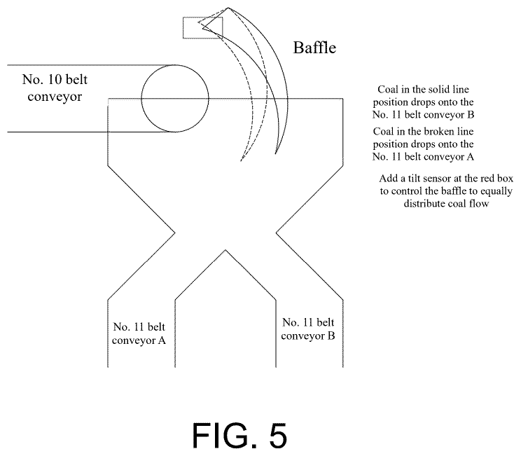

### DESCRIPTION OF THE EMBODIMENTS

In order to make the objectives, technical solutions, and advantages of the embodiments of the present invention clearer, the technical solutions in the embodiments of the present invention will be described clearly and completely below in conjunction with the accompanying drawings. Obviously, the embodiments described herein are some embodiments of the present invention, but are not all the embodiments. The components of the embodiments of the present invention described and illustrated in the accompanying drawings herein may be usually arranged and designed in various configurations.

Therefore, the detailed description to the embodiments of the present invention provided in the accompanying drawings is not intended to limit the scope claimed in the present invention, but merely represents the selected embodiments of the present invention. Based on the embodiments in the present invention, all the other embodiments obtained by those skilled in the art without making any inventive effect shall fall within the scope of protection of the present invention.

It should be noted that similar reference numerals and letters indicate similar items in the following accompanying drawings. Therefore, once a certain item is defined in a drawing, it does not need to be further defined and explained in the subsequent drawings.

In the description of the present invention, it should be noted that the orientations or positional relationships indicated by the terms “center”, “upper”, “lower”, “left”, “right”, “vertical”, “horizontal”, “inside”, “outside”, etc. are based on the orientations or positional relationships shown in the accompanying drawings or the conventional orientations or positional relationships of the product in the invention during use. These are merely for the convenience of describing the invention and simplifying the description, but are not intended to indicate or imply that the referred device or element must have a specific orientation, be constructed and operated in a specific orientation. Therefore, these terms shall not be construed as limiting the present invention.

It should be noted that the terms “first” and “second”, etc. are used for descriptive purposes only and should not be understood as indicating or implying relative importance or implicitly specifying the number of technical features indicated. Thus, features defined via the “first” and “second” may explicitly or implicitly include one or more of such features. In the description of the present application, “multiple” means two or more unless explicitly and specifically defined otherwise.

Moreover, the terms “horizontal”, “vertical,” etc., do not require components to be absolutely horizontal or vertical but may be slightly inclined. For example, “horizontal” merely indicates that the direction is more horizontal relative to “vertical” and does not mean that the structure must be completely horizontal but may be slightly inclined.

### Example 1

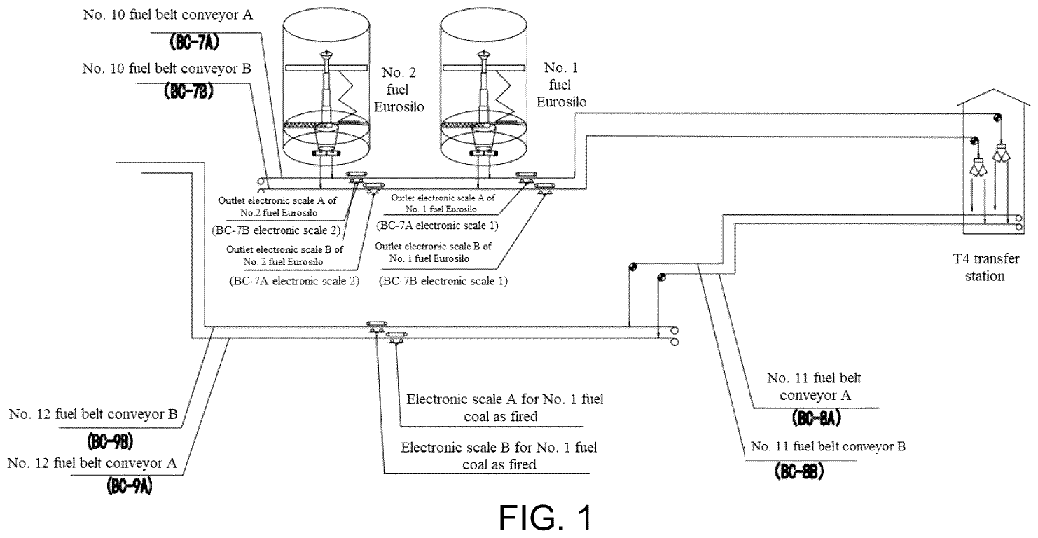

As shown in FIG. 1, the embodiment provides a coal blending and burning system based on a belt conveyor with a vertical process module, including:
a coal feeding system No. 1, provided with discharge ports 1A and 1B, for outputting a coal type A;
a coal feeding system No. 2, provided with discharge ports 2A and 2B, for outputting a coal type B;
a first belt conveyor A (i.e., No. 10 belt conveyor A), positioned directly facing the discharge ports 2A and 1A in sequence, and provided with an electronic scale 1A located at a rear side of the discharge port 1A and an electronic scale 2A located at a rear side of the discharge port 2A, respectively;
a first belt conveyor B (i.e., No. 10 belt conveyor B), positioned directly facing the discharge ports 2B and 1B in sequence, and provided with an electronic scale 1B located at a rear side of the discharge port 1B and an electronic scale 2B located at a rear side of the discharge port 2B, respectively;
a vertical drop tube, provided with an input port located at a top portion and an output port located at a bottom portion; the input port is connected to first belt conveyors A and B, and the output port is connected to the second belt conveyor;
a second belt conveyor (i.e., No. 11 belt conveyor) configured to transport a coal material discharged from the vertical drop tube;
a controller, connected to the coal feeding system No. 1, the coal feeding system No. 2, the electronic scales 1A, 2A, 1B, and 2B, respectively, for controlling coal blending of the coal types A and B on the first belt conveyor A, the first belt conveyor B, or the second belt conveyor.

In this embodiment, in the belt conveyor coal blending and co-combustion system, the coal feeding system No. 1 (coal type A) has two discharge ports (1A/1B) for the No. 10 belt conveyor A/B; and the coal feeding system No. 2 (coal type B) has two discharge ports (2A/2B) for the No. 10 belt conveyor A/B. Moreover, a downstream belt conveyor may be freely selected for the No. 10 belt conveyor A/B, and electronic scales are disposed at the discharge ports of the coal feeder on the No. 10 belt conveyor A/B along the coal flow direction. The downstream belt conveyor is also equipped with electronic scales to determine a flow rate. Therefore, the system may opt for a coal blending scheme directly on the belt conveyor.

Specifically, the following schemes are included:

Scheme I: direct coal blending on the belt conveyor at the outlet of the coal feeder

The process for controlling coal blending of the coal types A and B on the first belt conveyor A via the controller includes the following steps:
S101: start a conveyor of the first belt conveyor A; configure a coal-blending flow rate of the coal type A and a coal-blending flow rate of the coal type B;
S102: start the coal feeding systems No. 1 and No. 2, open the discharge ports 1A and 2A, and release a coal material onto the first belt conveyor A simultaneously;
S103: determine whether a flow rate detected by the electronic scale 2A matches the coal-blending flow rate of the coal type B; if not, adjust a discharge amount at the discharge port 2A and repeat step S103; otherwise, execute step S104;
S104: determine whether a difference between a flow rate detected by the electronic scale 1A and the flow rate detected by the electronic scale 2A matches the coal-blending flow rate of the coal type A; if not, adjust a discharge amount at the discharge port 1A and repeat step S104; otherwise, execute step S105; and
S105: repeat steps S103-S104 until a coal-blending stop command is received.

The same process applies to coal blending for the coal types A and B on the first belt conveyor B, including the following steps:
S111: start a conveyor of the first belt conveyor B; configure a coal-blending flow rate of the coal type A and a coal-blending flow rate of the coal type B;
S112: start the coal feeding systems No. 1 and No. 2, open the discharge ports 1B and 2B, and release a coal material onto the first belt conveyor B simultaneously;
S113: determine whether a flow rate detected by the electronic scale 2B matches the coal-blending flow rate of the coal type B; if not, adjust a discharge amount at the discharge port 2B and repeat step S103; otherwise, execute step S104;
S114: determine whether a difference between a flow rate detected by the electronic scale 1B and the flow rate detected by the electronic scale 2B matches the coal-blending flow rate of the coal type A; if not, adjust a discharge amount at the discharge port 1B and repeat step S114; otherwise, execute step S115; and
S115: repeat steps S113-S114 until a coal-blending stop command is received.

This scheme involves simultaneously opening two feeding ports of different coal feeding systems on the same belt conveyor. That is, when the No. 10 belt conveyor A is running, the discharge ports 1A and 2A are opened, and proportional coal blending is achieved by controlling the flow rates of the discharge ports.

This coal blending method is the most straightforward, and since the flow rates of different discharge ports may be controlled independently, the No. 10 belt conveyor may simultaneously transport mixed coal in different proportions through dual routes. However, since a weight of coal after blending is measured by the electronic scale at the outlet of the feeding system 1, the actual flow rate at the discharge port of the coal feeding system No. 1 needs to be calculated and confirmed, resulting in relatively delayed adjustments.

Scheme II: direct single-route coal blending on the No. 11 belt conveyor

The process for controlling coal blending of the coal types A and B on the second belt conveyor (No. 11 belt conveyor) via the controller includes the following steps:
S201: start conveyors of the first belt conveyors A and B, respectively; configure a coal-blending flow rate of the coal type A and a coal-blending flow rate of the coal type B;
S202: start the coal feeding systems No. 1 and No. 2, open the discharge ports 1A and 2B, and release a coal material onto the first belt conveyors A and B, respectively;
S203: coal materials on the first belt conveyors A and B all drop onto the second belt conveyor via the vertical drop tube for coal blending;
S204: determine whether a flow rate detected by the electronic scale 1A matches the coal-blending flow rate of the coal type A; if not, adjust a discharge amount at the discharge port 1A and repeat step S204; determine whether a flow rate detected by the electronic scale 2B matches the coal-blending flow rate of the coal type B; if not, adjust a discharge amount at the discharge port 2B and repeat step S204; and
S205: repeat step S204 until a coal-blending stop command is received.

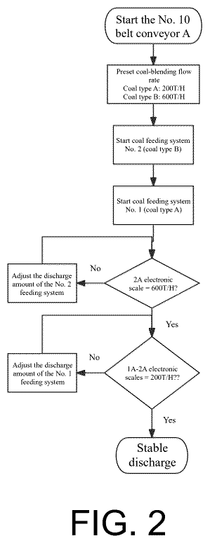

This scheme involves opening discharge ports on different sides of the two coal feeding systems such that the No. 10 belt conveyor A/B each carries one coal type for coaling blending on the No. 11 belt conveyor, as shown in FIG. 2. That is, when the No. 10 belt conveyor A is running, the discharge port 1A is opened; when the No. 10 belt conveyor B is running, the discharge port 2B is opened; and both routes of coal all drop onto the No. 11 belt conveyor A through the vertical drop tube for blending.

This coal blending method may enable the real-time control of flow rates on the No. 10 belt conveyor, with the most precise control of proportions. However, single-route operation would prolong the silo filling time and poses a risk of stopping the No. 11 belt conveyor in case of excessive instantaneous flow rates.

Scheme III: dual-route equal division coal blending on the No. 11 belt conveyor

The second belt conveyor (No. 11 belt conveyor) includes second belt conveyors A and B that are connected in parallel to an output port of the vertical drop tube; the third belt conveyor (No. 12 belt conveyor) includes third belt conveyors A and B; the third belt conveyor A is connected to the second belt conveyor A, and the third belt conveyor B is connected to the second belt conveyor B; the third belt conveyor A is provided with a third belt conveyor A electronic scale, and the third belt conveyor B is provided with a third belt conveyor B electronic scale; the vertical drop tube is internally provided with a baffle and a driver for driving the baffle to rotate, for distributing a coal material flowing from the input port of the vertical drop tube onto the second belt conveyors A and B.

Preferably, belt conveyors A and B are further disposed at a bottom portion of the vertical drop tube, and configured to transport a coal material to the second belt conveyors A and B, respectively.

The process for controlling coal blending of the coal types A and B on the second belt conveyor via the controller includes the following steps:
S301: start conveyors of the first belt conveyors A and B, respectively; configure a coal-blending flow rate of the coal type A and a coal-blending flow rate of the coal type B;
S302: start the coal feeding systems No. 1 and No. 2, open the discharge ports 1A and 2B, and release a coal material onto the first belt conveyors A and B, respectively;
S303: determine whether a flow rate detected by the electronic scale 1A matches the coal-blending flow rate of the coal type A; if not, adjust a discharge amount at the discharge port 1A and repeat step S303; determine whether a flow rate detected by the electronic scale 2B matches the coal-blending flow rate of the coal type B; if not, adjust a discharge amount at the discharge port 2B, and repeat step S303; and
S304: drive the baffle inside the vertical drop tube to rotate via the driver onto a middle position for distributing coal to the second belt conveyors A and B;
S305: determine whether a flow rate detected by the third belt conveyor A electronic scale matches an average value of a sum of the coal-blending flow rates of the coal types A and B; if not, adjust an angle of the baffle inside the vertical drop tube; determine whether a flow rate detected by the third belt conveyor B electronic scale matches an average value of a sum of the coal-blending flow rates of the coal types A and B; if not, adjust the angle of the baffle inside the vertical drop tube; and

S306: repeat steps S303-S305 until a coal-blending stop command is received.

This scheme involves opening the discharge ports on different sides of the two coal feeding systems such that the No. 10 belt conveyor A/B each carries one coal type, the baffle is used at the vertical drop tube to evenly distribute the coal flow onto the No. 11 belt conveyor A/B, thus ensuring that the No. 11 belt conveyor A/B contains mixed coal with the same proportion of coal types.

This coal blending scheme ensures dual-route coal feeding with relatively precise control of initial proportions. However, the coal blending is identical for both paths, and to meet dual-route requirements simultaneously, the flow rate of the high-proportion coal type is amplified at the No. 10 belt conveyor, posing a risk of belt conveyor overload and shutdown.

Scheme IV: coal blending with the feeding system on the No. 11 belt conveyor

The process for controlling coal blending of the coal types A and B on the second belt conveyor via the controller includes the following steps:

S401: start conveyors of the first belt conveyors A and B, respectively;

S402: start the coal feeding systems No. 1 and No. 2, open the discharge ports 1A and 2B, and release a coal material onto the first belt conveyors A and B, respectively; and

S403: drive the baffle inside the vertical drop tube to rotate via the driver such that the coal type B drops onto the second belt conveyor A completely, the coal type A is partially mixed with the coal type B via the baffle according to actual coal blending requirements and drops onto the second belt conveyor A, and a remainder drops onto the second belt conveyor B.

This scheme involves opening the discharge ports on different sides of the two coal feeding systems such that the No. 10 belt conveyor A/B each carries one coal type; the coal type B entirely drops onto a single belt conveyor when flows through the drop tube, while the coal type A is adjusted by the baffle according to actual blending requirements, and divided into the required flow to be mixed with the coal type B, and the excess flow of the coal type A is directed to another belt conveyor.

This method achieves two-level proportion control through the electronic scale of the No. 12 belt conveyor. However, its drawback lies in the need to reserve a single silo for the excessive coal type A.

Preferably, regardless of the coal blending method is chosen in the above schemes, the primary task on the control side is to achieve the PID control for the activated feeder. PID control is to adjust the discharge port amplitude based on the flow rate detected by the electronic scale of No. 10 belt conveyor. During initial operation, the system first sets a flow rate for the single feeding system according to the preset silo-filling proportion and flow rate. When the flow rate does not meet system requirements, the discharge port flow rate is automatically adjusted. Meanwhile, when the proportion of the coal type A is too high, the proportion of the coal type A is reduced to prevent deviations in combustion calorific value.

Preferably, a tilt sensor needs to be configured for the aforesaid schemes in need of a baffle to accurately distribute the flow rate of the No. 10 belt conveyor onto the No. 11 belt conveyor and to determine the flow rate stabilization with the electronic scale of the No. 12 belt conveyor. In the preliminary stage, the drop points and angles of different coal types need to be collected and enumerated to identify suitable monitoring zones, which are then used for PID determination with the electronic scale of the No. 12 belt conveyor.

Preferably, when coal blending is performed on belt conveyors, a fault interlocking function will be set in the system to ensure that all outputs are mixed coal. That is, after detecting discharge from the coal feeding system 2, the coal feeding system 1 discharges; when coal interruption is detected in either the coal feeding system 1 or the coal feeding system 2, the other coal feeding system stops discharging to prevent the coal type A from being discharged alone, causing deviations in calorific value.

Whether the coal feeding system No. 1 or No. 2 discharges is determined by determining a flow rate output by the electronic scale disposed at the discharge port of the coal feeding system No. 1 or No. 2.

Preferably, since the electronic scale of the No. 12 belt conveyor is located at a certain distance from the coal blending outlet of the No. 11 belt conveyor, the control time needs to be adjusted according to the time difference in data acquisition from the electronic scale of the No. 12 belt conveyor. Considering the non-linear adjustment of the discharge port, discharge range data of the discharge port should be collected in advance and set for the adjustment precision of the electronic scales.

After completing the above settings, the system undergoes testing. The system starts to run formally after ensuring safe and stable operation of the coal conveying system, and the coal blending way is chosen according to actual conditions for blending and silo filling.

The above describes the preferred specific embodiments of the present invention in detail. It should be understood that those skilled in the art could make numerous modifications and variations based on the concept of the present invention without any inventive effort. Therefore, any technical solution obtainable by those skilled in the art through logical analysis, reasoning, or limited number of experiments according to the concept of the present invention and on the basis of the prior art shall fall within the protection scope of the present invention.

What is claimed is:

1. A coal blending and burning system based on a belt conveyor with a vertical process module, comprising:
a coal feeding system No. 1, provided with discharge ports 1A and 1B, for outputting a coal type A;
a coal feeding system No. 2, provided with discharge ports 2A and 2B, for outputting a coal type B;
a first belt conveyor A, positioned directly facing the discharge ports 2A and 1A in sequence, and provided with an electronic scale 1A located at a rear side of the discharge port 1A and an electronic scale 2A located at a rear side of the discharge port 2A, respectively;
a first belt conveyor B, positioned directly facing the discharge ports 2B and 1B in sequence, and provided with an electronic scale 1B located at a rear side of the discharge port 1B and an electronic scale 2B located at a rear side of the discharge port 2B, respectively;
a vertical drop tube, provided with an input port located at a top portion and an output port located at a bottom portion; the input port is connected to the first belt conveyors A and B, and the output port is connected to the second belt conveyor;
a second belt conveyor, configured to transport a coal material discharged from the vertical drop tube;
a third belt conveyor, configured to transport a coal material discharged from the second belt conveyor to a coal supply end; and
a controller, connected to the coal feeding system No. 1, the coal feeding system No. 2, the electronic scales 1A, 2A, 1B, and 2B, respectively, for controlling coal blending of the coal types A and B on the first belt conveyor A, the first belt conveyor B, or the second belt conveyor.

2. The coal blending and burning system based on a belt conveyor with a vertical process module according to claim 1, wherein a process for controlling coal blending of the coal types A and B on the first belt conveyor A via the controller comprises the following steps:
S101: starting a conveyor of the first belt conveyor A; configuring a coal-blending flow rate of the coal type A and a coal-blending flow rate of the coal type B;
S102: starting the coal feeding systems No. 1 and No. 2, opening the discharge ports 1A and 2A, and releasing a coal material onto the first belt conveyor A simultaneously;
S103: determining whether a flow rate detected by the electronic scale 2A matches the coal-blending flow rate of the coal type B; if not, adjusting a discharge amount at the discharge port 2A and repeating step S103; otherwise, executing step S104;
S104: determining whether a difference between a flow rate detected by the electronic scale 1A and the flow rate detected by the electronic scale 2A matches the coal-blending flow rate of the coal type A; if not, adjusting a discharge amount at the discharge port 1A and repeating step S104; otherwise, executing step S105; and
S105: repeating steps S103-S104 until a coal-blending stop command is received.

3. The coal blending and burning system based on a belt conveyor with a vertical process module according to claim 1, wherein a process for controlling blending of the coal types A and B on the first belt conveyor B via the controller comprises the following steps:
S111: starting a conveyor of the first belt conveyor B; configuring a coal-blending flow rate of the coal type A and a coal-blending flow rate of the coal type B;
S112: starting the coal feeding systems No. 1 and No. 2, opening the discharge ports 1B and 2B, and releasing a coal material onto the first belt conveyor B simultaneously;
S113: determining whether a flow rate detected by the electronic scale 2B matches the coal-blending flow rate of the coal type B; if not, adjusting a discharge amount at the discharge port 2B and repeating step S103; otherwise, executing step S104;
S114: determining whether a difference between a flow rate detected by the electronic scale 1B and the flow rate detected by the electronic scale 2B matches the coal-blending flow rate of the coal type A; if not, adjusting a discharge amount at the discharge port 1B and repeating step S114; otherwise, executing step S115; and
S115: repeating steps S113-S114 until a coal-blending stop command is received.

4. The coal blending and burning system based on a belt conveyor with a vertical process module according to claim 1, wherein a process for controlling blending of the coal types A and B on the second belt conveyor via the controller comprises the following steps:
S201: starting conveyors of the first belt conveyors A and B, respectively; configuring a coal-blending flow rate of the coal type A and a coal-blending flow rate of the coal type B;
S202: starting the coal feeding systems No. 1 and No. 2, opening the discharge ports 1A and 2B, and releasing a coal material onto the first belt conveyors A and B, respectively;
S203: coal materials on the first belt conveyors A and B all dropping onto the second belt conveyor via the vertical drop tube for coal blending;
S204: determining whether a flow rate detected by the electronic scale 1A matches the coal-blending flow rate of the coal type A; if not, adjusting a discharge amount at the discharge port 1A and repeating step S204; determining whether a flow rate detected by the electronic scale 2B matches the coal-blending flow rate of the coal type B; if not, adjusting a discharge amount at the discharge port 2B, and repeating step S204; and
S205: repeating step S204 until a coal-blending stop command is received.

5. The coal blending and burning system based on a belt conveyor with a vertical process module according to claim 1, wherein the second belt conveyor comprises second belt conveyors A and B that are connected in parallel to an output port of the vertical drop tube; the third belt conveyor comprises third belt conveyors A and B; the third belt conveyor A is connected to the second belt conveyor A, and the third belt conveyor B is connected to the second belt conveyor B; the third belt conveyor A is provided with a third belt conveyor A electronic scale, and the third belt conveyor B is provided with a third belt conveyor B electronic scale; the vertical drop tube is internally provided with a baffle and a driver for driving the baffle to rotate, for distributing a coal material flowing from the input port of the vertical drop tube onto the second belt conveyors A and B.

6. The coal blending and burning system based on a belt conveyor with a vertical process module according to claim 5, wherein a process for controlling blending of the coal types A and B on the second belt conveyor via the controller comprises the following steps:
S301: starting conveyors of the first belt conveyors A and B, respectively; configuring a coal-blending flow rate of the coal type A and a coal-blending flow rate of the coal type B;
S302: starting the coal feeding systems No. 1 and No. 2, opening the discharge ports 1A and 2B, and releasing a coal material onto the first belt conveyors A and B, respectively;
S303: determining whether a flow rate detected by the electronic scale 1A matches the coal-blending flow rate of the coal type A; if not, adjusting a discharge amount at the discharge port 1A and repeating step S303; determining whether a flow rate detected by the electronic scale 2B matches the coal-blending flow rate of the coal type B; if not, adjusting a discharge amount at the discharge port 2B, and repeating step S303; and
S304: driving the baffle inside the vertical drop tube to rotate via the driver onto a middle position for distributing coal to the second belt conveyors A and B;
S305: determining whether a flow rate detected by the third belt conveyor A electronic scale matches an average value of a sum of the coal-blending flow rates of the coal types A and B; if not, adjusting an angle of the baffle inside the vertical drop tube; determining whether a flow rate detected by the third belt conveyor B electronic scale matches an average value of a sum of the coal-blending flow rates of the coal types A and B; if not, adjusting the angle of the baffle inside the vertical drop tube; and
S306: repeating steps S303-S305 until a coal-blending stop command is received.

7. The coal blending and burning system based on a belt conveyor with a vertical process module according to claim 5, wherein the process for controlling blending of the coal types A and B on the second belt conveyor via the controller comprises the following steps:
S401: starting conveyors of the first belt conveyors A and B, respectively;
S402: starting the coal feeding systems No. 1 and No. 2, opening the discharge ports 1A and 2B, and releasing a coal material onto the first belt conveyors A and B, respectively; and
S403: driving the baffle inside the vertical drop tube to rotate via the driver such that the coal type B drops onto the second belt conveyor A completely, the coal type A is partially mixed with the coal type B via the baffle according to actual coal blending requirements and drops onto the second belt conveyor A, and a remainder drops onto the second belt conveyor B.

8. The coal blending and burning system based on a belt conveyor with a vertical process module according to claim 5, wherein the vertical drop tube is further provided with a tilt sensor for measuring a rotation angle of the baffle.

9. The coal blending and burning system based on a belt conveyor with a vertical process module according to claim 5, wherein belt conveyors A and B are further disposed at a bottom portion of the vertical drop tube, and configured to transport a coal material to the second belt conveyors A and B, respectively.

10. The coal blending and burning system based on a belt conveyor with a vertical process module according to claim 1, wherein the controller further continuously executes an anti-coal-interruption interlocking protection step during the control process of coal blending: after detecting discharge from the coal feeding system 2, the coal feeding system 1 discharges; when coal interruption is detected in either the coal feeding system 1 or the coal feeding system 2, the other coal feeding system stops discharging; and
whether the coal feeding system No. 1 or No. 2 discharges is determined by determining a flow rate output by the electronic scale disposed at the discharge port of the coal feeding system No. 1 or No. 2.
